(19) United States
(12) Patent Application Publication
(10) Pub. No.: US 2010/0249330 A1
(43) Pub. Date: Sep. 30, 2010

(54) PROCESS FOR THE PREPARATION OF HIGH FLUIDITY PROPYLENE POLYMERS

(75) Inventors: Paola Massari, Ferrara (IT); Marco Ciarafoni, Ferrara (IT); Ofelia Fusco, Ferrara (IT); Hirofumi Murakami, Kawasaki (JP); Takeshi Nakajima, Kawasaki (JP); Shintaro Takemiya, Kawasaki (JP)

Correspondence Address: BASELL USA INC., NEWTOWN SQUARE CENTER, 3801 WEST CHESTER PIKE, BLDG. B, NEWTOWN SQUARE, PA, 19073, US

(73) Assignee: Basell Poliolefine Italia s.r.l., Milan (IT)

(21) Appl. No.: 12/734,174

(22) PCT Filed: Oct. 2, 2008
(86) PCT No.: PCT/EP2008/063243

§ 371 Date: Apr. 15, 2010

Related U.S. Application Data
(60) Provisional application No. 60/999,436, filed on Oct. 18, 2007.

(30) Foreign Application Priority Data
Oct. 15, 2007 (EP) 07118446.9

(51) Int. Cl. C08L 23/06; C08F 4/58; C08L 23/12

(52) U.S. Cl. 525/240; 526/125.3

(57) ABSTRACT

Process for the production of propylene polymers having a Melt Flow rate (230° C., 2.16 Kg) higher than 30 g/10′ and preferably higher than 50 g/10′ and also characterized by having broad molecular weight distribution (MWD) carried out in the presence of a catalyst system comprising (a) a solid catalyst component containing Mg, Ti, halogen and an electron donor compound selected from succinates;

(b) an alkylaluminum cocatalyst; and
(c) a silicon compound of formula R¹Si(OR)₃ in which R¹ is a branched alkyl and R is, independently, a C1-C10 alkyl.

This application is the U.S. national phase of International Application PCT/EP2008/063243, filed Oct. 2, 2008, claiming priority to European Patent Application 07118446.9 filed Oct. 15, 2007, and the benefit under 35 U.S.C. 119(e) of U.S. Provisional Application No. 60/999,436, filed Oct. 18, 2007; the disclosures of International Application PCT/EP2008/063243, European Patent Application 07118446.9 and U.S. Provisional Application No. 60/999,436, each as filed, are incorporated herein by reference.

The present invention relates to a process for the production of propylene polymers having a Melt Flow rate (230° C., 2.16 Kg) higher than 30 g/10′ and preferably higher than 50 g/10′ and also characterized by having broad molecular weight distribution (MWD). The molecular weight distribution is an important parameter for the behavior of propylene polymers. In general terms broadening of the molecular weight distribution brings about an improvement in terms of polymer processability (easiness of extrusion and in general flowability) and in terms of mechanical properties (higher flexural modulus). One of the preferred ways to obtain polymers with broad molecular weight distribution is to use catalyst systems that are intrinsically able to impart such a property to the polymer. WO00/63261 is representative of a document describing a Ziegler-Natta catalyst system able to provide polymers with broad MWD, which is based on (a) a catalyst component containing Mg, Ti, Cl and a succinate as internal donor, (b) an aluminum alkyl and (c) an external electron donor compound.

In the document EP 640624 it is disclosed a class of silicon compounds useful as external donors having formula (R¹O)₃Si—C(CH₃)₂—CH(R²)(R³) where each of R¹, R² and R³ are C1-C3 hydrocarbon groups. Catalyst systems based on these external donors are said to provide high activity, stereoregularity and higher melting point.

On the other hand, in WO02/30998 it is disclosed a catalyst system comprising (a) a catalyst component containing Mg, Ti, Cl and two internal electron donors having different extractability features, one selected from succinates and the other one selected from phthalates, (b) and aluminum alkyl and (c) an external electron donor compound. The external electron donor can be selected from monoalkyltrialkoxysilanes in order to produce polymers with a lower crystallinity.

None of these documents is concerned with the problem of producing propylene polymers having at the same time broad MWD and high melt flow rate. In certain applications in fact, particularly in thin wall injection molding (TWIM) it is necessary to use polymers with relatively high fluidity i.e., with a relatively lower molecular weight in order to have high quality moldings.

The low molecular weight polymers are commonly obtained by increasing the content of the chain transfer agent (molecular weight regulator). As the commonly used molecular weight regulator is hydrogen which is gaseous at the conventional polymerization conditions, its high content in the polymerization mixture increases the pressure of the reaction system making it necessary the use of equipments especially designed to withstand to higher pressure and thus more expensive. A possible solution, particularly for liquid-phase polymerization, would be to run that the plant at a lower temperature which can allow a reduced pressure, but this negatively impacts the efficiency of heat exchange and the relative plant productivity. Therefore, it would be necessary to have a catalyst system showing an improved hydrogen response, i.e., capability of producing polymers with a lower molecular weight in the presence of small amounts of hydrogen. Examples of catalysts having high hydrogen response are the Ziegler-Natta catalysts containing 1,3-diethers described for example in EP622380. Such catalysts however, are able to produce propylene polymers with high melt flow rates only in conjunction with narrow molecular weight distribution and therefore do not solve the problem.

The applicant has found that the selection of a specific type of catalyst system is able to solve the afore-mentioned problem. It is therefore an object of the present invention a process for the preparation of propylene polymers having a Polydispersity Index higher than 5, and melt index (230° C.; 2.16 Kg) higher than 30 g/10′, carried out in the presence of a catalyst system comprising (a) a solid catalyst component containing Mg, Ti, halogen and an electron donor compound selected from succinates;

(b) an alkylaluminum cocatalyst; and
(c) a silicon compound of formula R¹Si(OR)₃ in which R¹ is a branched alkyl and R is, independently, a C1-C10 alkyl.

Preferably, the solid catalyst component comprises Mg, Ti, halogen and an electron donor selected from succinates of formula (I):

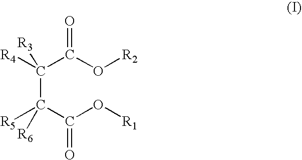

wherein the radicals R₁ and R₂, equal to or different from each other, are a C₁-C₂₀ linear or branched alkyl, alkenyl, cycloalkyl, aryl, arylalkyl or alkylaryl group, optionally containing heteroatoms; the radicals R₃ to R₆ equal to or different from each other, are hydrogen or a C₁-C₂₀ linear or branched alkyl, alkenyl, cycloalkyl, aryl, arylalkyl or alkylaryl group, optionally containing heteroatoms, and the radicals R₃ to R₆ which are joined to the same carbon atom can be linked together to form a cycle.

R₁ and R₂ are preferably C₁-C₈ alkyl, cycloalkyl, aryl, arylalkyl and alkylaryl groups. Particularly preferred are the compounds in which R₁ and R₂ are selected from primary alkyls and in particular branched primary alkyls. Examples of suitable R₁ and R₂ groups are methyl, ethyl, n-propyl, n-butyl, isobutyl, neopentyl, 2-ethylhexyl. Particularly preferred are ethyl, isobutyl, and neopentyl.

One of the preferred groups of compounds described by the formula (I) is that in which R₃ to R₅ are hydrogen and R₆ is a branched alkyl, cycloalkyl, aryl, arylalkyl and alkylaryl radical having from 3 to 10 carbon atoms. Specific examples of suitable monosubstituted succinate compounds are Diethyl sec-butylsuccinate, Diethyl thexylsuccinate, Diethyl cyclopropylsuccinate, Diethyl norbornylsuccinate, Diethyl perihydrosuccinate, Diethyl trimethylsilylsuccinate, Diethyl methoxysuccinate, Diethyl p-methoxyphenylsuccinate, Diethyl p-chlorophenylsuccinate diethyl phenylsuccinate, diethyl cyclohexylsuccinate, diethyl benzylsuccinate, diethyl cyclohexylmethylsuccinate, diethyl t-butylsuccinate, diethyl isobutylsuccinate, diethyl isopropylsuccinate, diethyl neopentylsuccinate, diethyl isopentylsuccinate, diethyl (1-trifluoromethylethyl)succinate, diethyl fluorenylsuccinate, 1-(ethoxycarbo diisobutyl phenylsuccinate, Diisobutyl sec-butylsuccinate, Diisobutyl thexylsuccinate, Diisobutyl cyclopropylsuccinate, Diisobutyl norbornylsuccinate, Diisobutyl perihydrosuccinate, Diisobutyl trimethylsilylsuccinate, Diisobutyl methoxysuccinate, Diisobutyl p-methoxyphenylsuccinate, Diisobutyl p-chlorophenylsuccinate, diisobutyl cyclohexylsuccinate, diisobutyl benzylsuccinate, diisobutyl cyclohexylmethylsuccinate, diisobutyl t-butylsuccinate, diisobutyl isobutylsuccinate, diisobutyl isopropylsuccinate, diisobutyl neopentylsuccinate, diisobutyl isopentylsuccinate, diisobutyl (1-trifluoromethylethyl)succinate, diisobutyl fluorenylsuccinate, Dineopentyl sec-butylsuccinate, Dineopentyl thexylsuccinate, Dineopentyl cyclopropylsuccinate, Dineopentyl norbornylsuccinate, Dineopentyl perihydrosuccinate, Dineopentyl trimethylsilylsuccinate, Dineopentyl methoxysuccinate, Dineopentyl p-methoxyphenylsuccinate, Dineopentyl p-chlorophenylsuccinatedineopentyl phenylsuccinate, dineopentyl cyclohexylsuccinate, dineopentyl benzylsuccinate, dineopentyl cyclohexylmethylsuccinate, dineopenthyl t-butylsuccinate, dineopentyl isobutylsuccinate, dineopentyl isopropylsuccinate, dineopentyl neopentylsuccinate, dineopentyl isopentylsuccinate, dineopentyl (1-trifluoromethylethyl)succinate, dineopentyl fluorenylsuccinate. Another preferred group of compounds within those of formula (I) is that in which at least two radicals from R₃ to R₆ are different from hydrogen and are selected from C₁-C₂₀ linear or branched alkyl, alkenyl, cycloalkyl, aryl, arylalkyl or alkylaryl group, optionally containing heteroatoms. Particularly preferred are the compounds in which the two radicals different from hydrogen are linked to the same carbon atom. Furthermore, also the compounds in which at least two radicals different from hydrogen are linked to different carbon atoms, that is R₃ and R₅ or R₄ and R₆ are particularly preferred. Specific examples of suitable disubstituted succinates are: diethyl 2-,2-dimethylsuccinate, diethyl 2-ethyl-2-methylsuccinate, diethyl 2-Benzyl-2-isopropylsuccinate, Diethyl 2-cyclohexylmethyl-2-isobutylsuccinate, Diethyl 2-cyclopentyl-2-n-butyl succinate, Diethyl 2,2-diisobutylsuccinate, Diethyl 2-cyclohexyl-2-ethylsuccinate, Diethyl 2-isopropyl-2-methylsuccinate, Diethyl 2-tetradecyl-2 ethyl succinate, Diethyl 2-isobutyl-2-ethylsuccinate, Diethyl 2-(1-trifluoromethyl-ethyl)-2-methylsuccinate, Diethyl 2-isopentyl-2-isobutylsuccinate, Diethyl 2-phenyl 2-n-butylsuccinate, diisobutyl 2-,2-dimethylsuccinate, diisobutyl 2-ethyl-2-methylsuccinate, Diisobutyl 2-benzyl-2 isopropylsuccinate, Diisobutyl 2-cyclohexylmethyl-2-isobutylsuccinate, Diisobutyl 2-cyclopentyl-2-n-butylsuccinate, Diisobutyl 2,2-diisobutylsuccinate, Diisobutyl 2-cyclohexyl-2-ethylsuccinate, Diisobutyl ′2-isopropyl-2-methylsuccinate, Diisobutyl 2-tetradecyl-2-ethylsuccinate, Diisobutyl 2-isobutyl-2-ethylsuccinate, Diisobutyl 2-(1-trifluoromethyl-ethyl)-2-methylsuccinate, Diisobutyl 2-isopentyl-2-isobutylsuccinate, Diisobutyl 2-phenyl 2-nButyl-succinate, dineopentyl 2-,2-dimethylsuccinate, dineopentyl 2-ethyl-2-methylsuccinate, Dineopentyl 2-Benzyl-2 isopropylsuccinate, Dineopentyl 2-cyhexylmethyl-2-isobutylsuccinate, Dineopentyl 2-cyclopentyl-2-n-butylsuccinate, Dineopentyl 2,2-diisobutylsuccinate, Dineopentyl 2-cyclohexyl-2-ethylsuccinate, Dineopentyl 2-isopropyl-2-methylsuccinate, Dineopentyl 2-tetradecyl-2 ethylsuccinate, Dineopentyl 2-isobutyl-2-ethylsuccinate, Dineopentyl 2-(1-trifluoromethyl-ethyl)-2-methylsuccinate, Dineopentyl 2-isopentyl-2-isobutylsuccinate, Dineopentyl 2-phenyl 2-n-butylsuccinate.

Furthermore, also the compounds in which at least two radicals different from hydrogen are linked to different carbon atoms, that is R₃ and R₅ or R₄ and R₆ are particularly preferred. Specific examples of suitable compounds are Diethyl 2,3bis(trimethylsilyl)succinate, Diethyl 2,2-secbutyl-3-methylsuccinate, Diethyl 2-(3,3,3,trifluoropropyl)-3-methylsuccinate, Diethyl 2,3 bis(2-ethyl-butyl)succinate, Diethyl 2,3-diethyl-2-isopropylsuccinate, Diethyl 2,3-diisopropyl-2-methylsuccinate, Diethyl 2,3-dicyclohexyl-2-methyl diethyl 2,3-dibenzylsuccinate, diethyl 2,3-diisopropylsuccinate, diethyl 2,3-bis(cyclohexylmethyl)succinate, Diethyl 2,3-di-t-butylsuccinate, Diethyl 2,3-diisobutylsuccinate, Diethyl 2,3-di neopentylsuccinate, Diethyl 2,3-diisopentylsuccinate, Diethyl 2,3-(1-trifluoromethyl-ethyl)succinate, Diethyl 2,3-tetradecylsuccinate, Diethyl 2,3-fluorenylsuccinate, Diethyl 2-isopropyl-3-isobutylsuccinate, Diethyl 2-terbutyl-3-isopropylsuccinate, Diethyl 2-ipropyl-3-cyclohexylsuccinate, Diethyl 2-isopentyl-3-cyclohexylsuccinate, Diethyl 2-tetradecyl-3-cyclohexylmethylsuccinate, Diethyl 2-cyclohexyl-3-cyclopentylsuccinate. Diisobutyl 2,3-diethyl-2-isopropylsuccinate, Diisobutyl 2,3-diisopropyl-2-methylsuccinate, Diisobutyl 2,3-dicyclohexyl-2-methyl, diisobutyl 2,3-dibenzylsuccinate, diisobutyl 2,3-diisopropylsuccinate, diisobutyl 2,3-bis(cyclohexylmethyl)succinate, Diisobutyl 2,3-di-t-butylsuccinate, Diisobutyl 2,3-diisobutylsuccinate, Diisobutyl 2,3-dineopentylsuccinate, Diisobutyl 2,3-diisopentylsuccinate, Diisobutyl 2,3-(1-trifluoromethyl-ethyl)succinate, Diisobutyl 2,3-tetradecylsuccinate, Diisobutyl 2,3-fluorenylsuccinate, Diisobutyl 2-ipropyl-3-ibutylsuccinate, Diisobutyl 2-terbutyl-3-ipropylsuccinate, Diisobutyl 2-ipropyl-3-cyclohexylsuccinate, Diisobutyl 2-isopentyl-3-cyclohexylsuccinate, Diisobutyl 2-tetradecyl-3-cyclohexylmethylsuccinate, Diisobutyl 2-cyclohexyl-3-cyclopentylsuccinate, Dineopentyl 2,3bis(trimethylsilyl)succinate, Dineopentyl 2,2-secbutyl-3-methylsuccinate, Dineopentyl 2-(3,3,3,trifluoropropyl)-3-methylsuccinate, Dineopentyl 2,3 bis(2-ethyl-butyl)succinate, Dineopentyl 2,3-diethyl-2-isopropylsuccinate, Dineopentyl 2,3-diisopropyl-2-methylsuccinate, Dineopentyl 2,3-dicyclohexyl-2-methyl, dineopentyl 2,3-dibenzylsuccinate, dineopentyl 2,3-diisopropylsuccinate, dineopentyl 2,3-bis(cyclohexylmethyl)succinate, Dineopentyl 2,3-di-t-butylsuccinate, Dineopentyl 2,3-diisobutylsuccinate, Dineopentyl 2,3-dineopentylsuccinate, Dineopentyl 2,3-diisopentylsuccinate, Dineopentyl 2,3-(1-trifluoromethyl-ethyl)succinate, Dineopentyl 2,3-tetradecylsuccinate, Dineopentyl 2,3-fluorenylsuccinate, Dineopentyl 2-ipropyl-3-ibutylsuccinate, Dineopentyl 2-terbutyl-3-isopropylsuccinate, Dineopentyl 2-isopropyl-3-cyclohexylsuccinate, Dineopentyl 2-isopentyl-3-cyclohexylsuccinate, Dineopentyl 2-tetradecyl-3-cyclohexylmethyl succinate, Dineopentyl 2-cyclohexyl-3-cyclopentylsuccinate. Particularly preferred are the solid catalyst components in which the Ti atoms derive from a titanium compound which contains at least one Ti-halogen bond and the Mg atoms derive from magnesium chloride. In a still more preferred aspect both the titanium compound and the electron donor of formula (I) are supported on magnesium dichloride. Preferably, in the catalyst of the present invention at least 70% of the titanium atoms and more preferably at least 90% of them, are in the +4 valence state.

In a particular embodiment, the magnesium dichloride is in active form. The active form of magnesium dichloride present in the catalyst components of the invention is recognizable by the fact that in the X-ray spectrum of the catalyst component the major intensity reflection which appears in the spectrum of the non-activated magnesium dichloride (having usually surface area smaller than 3 m²/g) is no longer present, but in its place there is a halo with the position of the maximum intensity shifted with respect to the position of the major intensity reflection, or by the fact that the major intensity reflection presents a half-peak breadth at least 30% greater that the one of the corresponding reflection of the non-activated Mg dichloride. The most active forms are those in which the halo appears in the X-ray spectrum of the solid catalyst component.

In the case of the most active forms of magnesium dichloride, the halo appears in place of the reflection which in the spectrum of the non-activated magnesium chloride is situated at the interplanar distance of 2.56 Å.

Preferred titanium compounds are the halides or the compounds of formula TiXₙ(OR¹)₄₋ₙ, where 1≦n≦3, X is halogen, preferably chlorine, and R¹ is C₁-C₁₀ hydrocarbon group. Especially preferred titanium compounds are titanium tetrachloride and the compounds of formula TiCl₃OR¹ where R¹ has the meaning given above and in particular selected from methyl, n-butyl or isopropyl.

According to a preferred method, the solid catalyst component can be prepared by reacting a titanium compound of formula Ti(OR)_{n-y}X_{y}, where n is the valence of titanium and y is a number between 1 and n, preferably TiCl₄, with a magnesium chloride deriving from an adduct of formula MgCl₂.pROH, where p is a number between 0.1 and 6, preferably from 2 to 3.5, and R is a hydrocarbon radical having 1-18 carbon atoms. The adduct can be suitably prepared in spherical form by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. Examples of spherical adducts prepared according to this procedure are described in U.S. Pat. No. 4,399,054 and U.S. Pat. No. 4,469,648. The so obtained adduct can be directly reacted with the Ti compound or it can be previously subjected to thermal controlled dealcoholation (80-130° C.) so as to obtain an adduct in which the number of moles of alcohol is generally lower than 3, preferably between 0.1 and 2.5. The reaction with the Ti compound can be carried out by suspending the adduct (dealcoholated or as such) in cold TiCl₄ (generally 0° C.); the mixture is heated up to 80-130° C. and kept at this temperature for 0.5-2 hours. The treatment with TiCl₄ can be carried out one or more times. The internal donor can be added during the treatment with TiCl₄ and the treatment with the electron donor compound can be repeated one or more times. Generally, the succinate of formula (I) is used in molar ratio with respect to the MgCl₂ of from 0.01 to 1 preferably from 0.05 to 0.5. The preparation of catalyst components in spherical form is described for example in European patent application EP-A-395083 and in the International patent application WO98/44009. The solid catalyst components obtained according to the above method show a surface area (by B.E.T. method) generally between 20 and 500 m²/g and preferably between 50 and 400 m²/g, and a total porosity (by B.E.T. method) higher than 0.2 cm³/g preferably between 0.2 and 0.6 cm³/g. The porosity (Hg method) due to pores with radius up to 10,000 Å generally ranges from 0.3 to 1.5 cm³/g, preferably from 0.45 to 1 cm³/g.

A further method to prepare the solid catalyst component of the invention comprises halogenating magnesium dihydrocarbyloxide compounds, such as magnesium dialkoxide or diaryloxide, with solution of TiCl₄ in aromatic hydrocarbon (such as toluene, xylene etc.) at temperatures between 80 and 130° C. The treatment with TiCl₄ in aromatic hydrocarbon solution can be repeated one or more times, and the succinate is added during one or more of these treatments.

In any of these preparation methods the desired succinate can be added as such or, in an alternative way, it can be obtained in situ by using an appropriate precursor capable to be transformed in the desired electron donor compound by means, for example, of known chemical reactions such as esterification, transesterification etc. Generally, the succinate of formula (I) is used in molar ratio with respect to the MgCl₂ of from 0.01 to 1 preferably from 0.05 to 0.5.

The alkyl-Al compound (b) is preferably selected from the trialkyl aluminum compounds such as for example triethylaluminum, triisobutylaluminum, tri-n-butylaluminum, tri-n-hexylaluminum, tri-n-octylaluminum. It is also possible to use mixtures of trialkylaluminum's with alkylaluminum halides, alkylaluminum hydrides or alkylaluminum sesquichlorides such as AlEt₂Cl and Al₂Et₃Cl₃.

The silicon compound (c) is used as external electron donor and is preferably selected from the compounds in which R is a C1-C4 linear alkyl, preferably methyl or ethyl. The group R′ is a branched alkyl which can be linked to the Si atom through a carbon atom that can be primary, secondary or tertiary.

Non limitative examples of branched alkyls linked to the Si atom through a primary carbon atom are isobutyl, isopentyl, 2-ethylhexyl, cycloehxylmethyl.

Non limitative examples of branched alkyls linked to the Si atom through a secondary carbon atom are isopropyl cyclopropyl, cyclopentyl, cyclohexyl.

Non limitative examples of branched alkyls linked to the Si atom through a tertiary carbon atom are t-butyl, thexyl, (2,3-dimethyl-2-butyl), 2,3-dimethyl-2-pentyl.

Silicon compounds in which the branched alkyl is linked to the Si atom through a tertiary carbon atom are preferred and, among them, thexyltrimethoxysilane is the most preferred. The catalyst of the invention is able to polymerize any kind of CH₂═CHR olefins in which R is hydrogen or a C1-C10 hydrocarbon group. However, as mentioned above it is particularly suited for the preparation of propylene polymers having melt flow rate higher than 30 g/10′, preferably higher than 50 and more preferably higher than 70 g/10′ coupled with a MWD (expressed as polydispersity index determined as described hereinafter) higher than 5, preferably higher than 5.3 and more preferably higher than 6.

Such propylene polymers which can also be characterized by a xylene insoluble fraction at room temperature higher than 93% wt and preferably higher than 94% wt, can be used as such for a variety of applications or, most commonly, included as the crystalline component, in the heterophasic compositions which comprise, in addition to the said crystalline portion, also a fraction comprising ethylene copolymers with propylene and/or higher alpha-olefins usually in the range of from 10 to 90% wt containing from 20 to 80% by weight of ethylene. Such ethylene copolymers have a xylene solubility at room temperature higher than 50% wt, preferably higher than 70% and more preferably higher than 80%.wt.

When included in such compositions the propylene polymers have a MFR higher than 80 g/10′ and preferably higher than 100 g/10′ and especially in the range 100-170 g/10′ while the whole heterophasic composition can have a melt flow rate ranging from 20 to 60 g/10. When an extremely high fluidity is necessary the isotactic propylene polymers included in the heterophasic composition can reach values in the range 200-400 g/10′ with a MFR range for the whole composition being from 60 to 150 g/10′ and preferably from higher than 100 g/10′ to 150 g/10′ more preferably from 120 to 150 g/10′. The heterophasic compositions so prepared are endowed with a good stiffness/impact resistance balance and excellent spiral flow characteristics.

Any kind of polymerization process can be used with the catalysts of the invention that are very versatile. The polymerization can be carried out for example in slurry using as diluent a liquid inert hydrocarbon, or in bulk using the liquid monomer (propylene) as a reaction medium, or in solution using either monomers or inert hydrocarbons as solvent for the nascent polymer. Moreover, it is possible to carry out the polymerization process in gas-phase operating in one or more fluidized or mechanically agitated bed reactors.

The process of the present invention is particularly advantageous for producing said isotactic propylene polymers with high fluidity in liquid phase because in such a type of process the pressure problems connected to the use of increased amounts of hydrogen is more evident. As mentioned, the liquid phase process can be either in slurry, solution or bulk (liquid monomer). This latter technology is the most preferred and can be carried out in various types of reactors such as continuous stirred tank reactors, loop reactors or plug-flow ones. The polymerization is generally carried out at temperature of from 20 to 120° C., preferably of from 40 to 85° C. When the polymerization is carried out in gas-phase the operating pressure is generally between 0.5 and 10 MPa, preferably between 1 and 5 MPa. In the bulk polymerization the operating pressure is generally between 1 and 6 MPa preferably between 1.5 and 4 MPa. According to one of the preferred process technology the heterophasic compositions containing a crystalline portion with high fluidity are prepared by first polymerizing in liquid monomer, preferably in loop reactor, propylene in the presence of hydrogen amounts able to give isotactic propylene polymer with a MFR higher than 50 g/10′, then in a successive step ethylene and propylene or higher alpha-olefins are polymerized in a gas-phase in order to prepare the xylene soluble copolymer portion.

The catalyst of the present invention can be used as such in the polymerization process by introducing it directly into the reactor. In the alternative, the catalyst can be pre-polymerized before being introduced into the first polymerization reactor. The term pre-polymerized, as used in the art, means a catalyst which has been subject to a polymerization step at a low conversion degree. According to the present invention a catalyst is considered to be pre-polymerized when the amount the polymer produced is from about 0.1 up to about 1000 g per gram of solid catalyst component.

The pre-polymerization can be carried out with the α-olefins selected from the same group of olefins disclosed before. In particular, it is especially preferred pre-polymerizing ethylene or mixtures thereof with one or more α-olefins in an amount up to 20% by mole. Preferably, the conversion of the pre-polymerized catalyst component is from about 0.2 g up to about 500 g per gram of solid catalyst component.

The pre-polymerization step can be carried out at temperatures from 0 to 80° C. preferably from 5 to 50° C. in liquid or gas-phase. The pre-polymerization step can be performed in-line as a part of a continuous polymerization process or separately in a batch process. The batch pre-polymerization of the catalyst of the invention with ethylene in order to produce an amount of polymer ranging from 0.5 to 20 g per gram of catalyst component is particularly preferred.

The following examples are given in order to better illustrate the invention without limiting it.

### Characterization

### Determination of X.I.

2.50 g of polymer were dissolved in 250 ml of o-xylene under stirring at 135° C. for 30 minutes, then the solution was cooled to 25° C. and after 30 minutes the insoluble polymer was filtered off. The resulting solution was evaporated in nitrogen flow and the residue was dried and weighed to determine the percentage of soluble polymer and then, by difference, the xylene insoluble fraction (%).

### Melt Flow Rate (MFR)

Determined according to ISO 1133 (230° C., 2.16 Kg)

### Polydispersity Index (P.I.)

Determined at a temperature of 200° C. by using a parallel plates rheometer model RMS-800 marketed by RHEOMETRICS (USA), operating at an oscillation frequency which increases from 0.1 rad/sec to 100 rad/sec. The value of the polydispersity index is derived from the crossover modulus by way of the equation:

P.I.=10⁵/Gc

in which Gc is the crossover modulus defined as the value (expressed in Pa) at which G′=G″ wherein G′ is the storage modulus and G″ is the loss modulus.

### Flexural Modulus

Determined according to ISO 178

### IZOD Impact Strength

Determined according to ISO 180/1A

Spiral flow Measurement Test—The spiral flow evaluation comprises injecting molten polymer into the center of a hollow spiral mold, and measuring the total length of solidified resin to determine how far the material will flow before it solidifies under specified conditions of pressure and temperature:

| | SANDRETTO |
|---|---|
| Injection machine | Series 7 190 |
| Clamping force | 190 ton |
| Screw diameter | 50 mm |
| Maximum volume of the injected | 450 cc |
| Thickness of the spiral | 2.5 mm |
| Width of the spiral | 12.7 mm |
| Melting temperature | 230° C. |
| Mold Temperature | 40° C. |
| Total cycle time | 31 seconds |
| Cooling time | 20 seconds |

The spiral flow measurements are taken at four different pressures:

Pressure Measured at
Machine

40 bar
80 bar

### EXAMPLES

### Propylene General Polymerization Procedure for Solid Catalyst Component Obtained from General Procedure A

In a 4-liter autoclave, purged with nitrogen flow at 70° C. for two hours, 75 ml of anhydrous hexane containing 760 mg of AlEt₃, of thexyltrimethoxysilane (TEAL/thexyltrimethoxysilane molar ratio 20) and 10 mg of solid catalyst component were introduced in propylene flow at 30° C. The autoclave was closed. The amount of hydrogen reported in table 1 was added and then, under stirring, 1.2 Kg of liquid propylene were fed. The temperature was raised to 70° C. in five minutes and the polymerization was carried out at this temperature for two hours. The non-reacted propylene was removed, the polymer was recovered and dried at 70° C. under vacuum for three hours and then weighed and analyzed for the determination of the Mg residues by which the activity of the catalyst is calculated.

### Polymerization Procedure for the Preparation of Propylene Heterophasic Copolymers (B)

Into a liquid monomer loop polymerization reactor a propylene homopolymer (component (A)) is produced by feeding separately in a continuous and constant flow the catalyst component in a propylene flow, the aluminum triethyl (TEAL), Thexyltrimethoxysilane as external donor, hydrogen (used as molecular weight regulator) and propylene to reach the conditions reported in table 2.

The polypropylene homopolymer produced in the first reactor is discharged in a continuous flow and, after having been purged of unreacted monomers, is introduced, in a continuous flow, into the gas-phase polymerization reactor, together with quantitatively constant flow of hydrogen, ethylene and propylene in the gas state to produce a propylene/ethylene copolymer (component (B). Polymerization conditions, molar ratio of the reactants and composition of the copolymers obtained are shown in Table 2.

The polymer particles exiting the final reactor are subjected to a steam treatment to remove the reactive monomers and volatile substances, and then dried.

### General Procedure for Preparation of the Spherical Adduct

An initial amount of microspheroidal MgCl₂.2.8C₂H₅OH was prepared according to the method described in ex.2 of WO98/44009 but operating on larger scale and setting the stirring conditions so as to obtain an adduct having an average particle size of 25 μm.

### Example 1-3

### Preparation of the Solid Catalyst Component

Into a 500 mL four-necked round flask, purged with nitrogen, 250 ml of TiCl₄ are introduced at 0° C. While stirring, 10.0 g of microspheroidal MgCl₂.1.8C₂H₅OH (prepared according to the method described in ex.2 of U.S. Pat. No. 4,399,054 but operating at 3000 rpm instead of 10000 rpm) and 9.1 mmol of diethyl 2,3-(diisopropyl)succinate are added. The temperature is raised to 100° C. and maintained for 120 min. Then, the stirring is discontinued, the solid product was allowed to settle and the supernatant liquid is siphoned off. Then the following operations are repeated twice: 250 ml of fresh TiCl₄ are added, the mixture is reacted at 120° C. for 60 min and the supernatant liquid is siphoned off. The solid is washed six times with anhydrous hexane (6×100 mL) at 60° C. Propylene homopolymer was prepared by carrying out a bulk polymerization according to the general polymerization procedure A. Specific polymerization conditions and polymer characteristics are reported in Table 1.

### Comparison Example 1-2

Polymerizations were carried out with the same conditions of example 1 and 3 with the difference that Dicyclopentyldimethoxysilane was used instead of thexyltrimethoxysilane.

### Examples 4-5 and Comparison Example 6

Heterophasic compositions were prepared according to the general polymerization procedure B using the same catalyst system described in examples 1-3 for examples 4 and 5 while in comparison example 6 it was used the catalyst system described in example 2 of EP728769. Specific polymerization conditions and polymer characteristics are reported in Table 2.

### Example 7

A Heterophasic composition was prepared according to the general polymerization procedure B using the same catalyst system described in examples 1-3 and a higher amount of hydrogen in the first step of the polymerization. Specific polymerization conditions and polymer characteristics are reported in Table 3.

TABLE 1

| | Example | | | | |
|---|---|---|---|---|---|
| | 1 | 2 | 3 | Comp. 1 | Comp. 2 |
| H₂ (cc) | 10000 | 15000 | 20000 | 10000 | 20000 |
| MFR (g/10′) | 100 | 190 | 340 | 45 | 161 |
| PI | 6.2 | 6.5 | 6.3 | 6.3 | 6.2 |
| Activity (Kg/g) | 58 | 50 | 47 | 43.5 | 38.5 |

TABLE 2

| | Example | | |
|---|---|---|---|
| | 4 | 5 | Comp. 6 |
| Liquid phase | | | |
| polymerization | | | |
| T (° C.) | 75 | 70 | 80 |
| H₂ | | | |
| MFR(g/10′) | 115 | 250 | 250 |
| PI | 6.3 | 6.5 | 3.5 |
| XI | 97.5 | 97 | na |
| Gas-phase | | | |
| ethylene/propylene | | | |
| copolymerization | | | |
| % wt of copolymer B | 23 | 21 | 20.5 |
| % wt C2 copolymer B | 44 | 47 | 55 |
| Final Composition | | | |
| C2% total | 9.9 | 9.9 | 11.4 |
| XS | 21.9 | 21.7 | 18 |
| MFR(g/10′) | 39.5 | 75 | 100 |
| Flexural Modulus | 1350 | 1235 | 1250 |
| (MPa) | | | |
| Izod 23° C. | 5.2 | 3.4 | 3.5 |
| Spiral flow | | | |
| 40 bar | | 1125 | 1070 |
| 80 bar | | 1810 | 1690 |

TABLE 3

| | Example |
|---|---|
| | 7 |
| Liquid phase | |
| polymerization | |
| T (° C.) | 70 |
| H₂ | |
| MFR(g/10′) | 330 |
| PI | 6 |
| XI | 95.3 |
| Gas-phase | |
| ethylene/propylene | |
| copolymerization | |
| % wt of copolymer B | 22 |
| % wt C2 copolymer B | 48 |
| Final Composition | |
| C2% total | 10.3 |
| XS | 22 |
| MFR(g/10′) | 115 |
| Flexural Modulus | 1140 |
| (MPa) | |
| Izod 23° C. | 2.6 |

1. A process for the preparation of propylene polymers having a Polydispersity Index higher than 5 and a melt flow rate measured according to ISO 1133 (230° C.; 2.16 Kg) higher than 30 g/10′, carried out in the presence of a catalyst system comprising:
(a) a solid catalyst component containing Mg, Ti and halogen atoms, and an electron donor compound selected from succinates;
(b) an alkylaluminum cocatalyst; and
(c) a silicon compound of formula R¹Si(OR)₃ in which R¹ is a branched alkyl and R is, independently, a C1-C10 alkyl.

2. The process according to claim 1 in which the electron donor compound is selected from succinates of formula (I): 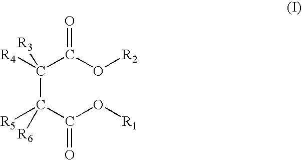
wherein the radicals R₁ and R₂, equal to or different from each other, are a C₁-C₂₀ linear or branched alkyl, alkenyl, cycloalkyl, aryl, arylalkyl or alkylaryl group, optionally containing heteroatoms; the radicals R₃ to R₆ equal to or different from each other, are hydrogen or a C₁-C₂₀ linear or branched alkyl, alkenyl, cycloalkyl, aryl, arylalkyl or alkylaryl group, optionally containing heteroatoms, and the radicals R₃ to R₆ which are joined to the same carbon atom can be linked together to form a cycle.

3. The process according to claim 1 wherein the Ti atoms derive from a titanium compound which contains at least one Ti-halogen bond and the Mg atoms derive from magnesium chloride.

4. The process according to claim 1 in which in the silicon compound (c), R is a C1-C4 linear alkyl, and the group R¹ is a branched alkyl which can be linked to the Si atom through a carbon atom that can be primary, secondary or tertiary.

5. The process according to claim 1 in which the silicon compound (c) is thexyltrimethoxysilane.

6. The process according to claim 1 in which the propylene polymers have a melt flow rate higher than 50 and a polydispersity index higher than 5.3.

7. A process for the preparation of a propylene polymer composition comprising in a first step (A) polymerizing propylene in the presence of hydrogen and a catalyst system comprising (a) a solid catalyst component containing Mg, Ti and halogen atoms and an electron donor compound selected from succinates; (b) an alkylaluminum cocatalyst; and (c) a silicon compound of formula R¹Si(OR)₃ in which R¹ is a branched alkyl and R is, independently, a C1-C10 alkyl, thereby forming a propylene polymer having a xylene insoluble fraction at room temperature higher than 93% wt and in a second step (B) carried out in the presence of the propylene polymer produced in (A) polymerizing ethylene and propylene or higher alpha-olefins thereby forming an ethylene copolymer with propylene and/or higher alpha-olefins having a xylene solubility at room temperature higher than 50% wt.

8. The process according to claim 7 in which the propylene polymer produced in step (A) has a melt flow rate higher than 80 g/10.

9. The process according to claim 7 in which the silicon compound (c) is thexyltrimethoxysilane.

10. The process according to claim 7 in which the electron donor compound is selected from succinates of formula (I): 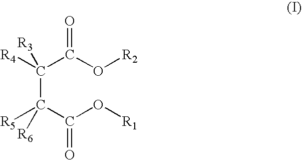
wherein the radicals R₁ and R₂, equal to or different from each other, are a C₁-C₂₀ linear or branched alkyl, alkenyl, cycloalkyl, aryl, arylalkyl or alkylaryl group, optionally containing heteroatoms; the radicals R₃ to R₆ equal to or different from each other, are hydrogen or a C₁-C₂₀ linear or branched alkyl, alkenyl, cycloalkyl, aryl, arylalkyl or alkylaryl group, optionally containing heteroatoms, and the radicals R₃ to R₆ which are joined to the same carbon atom can be linked together to form a cycle.

11. (canceled)

12. Heterophasic compositions having melt flow rate determined according to ISO 1133 (230° C.; 2.16 Kg) higher than 100 g/10′ comprising:
(A) 50-90% by weight of a propylene homo or copolymer with other olefins having a polydispersity index higher than 5, an amount insoluble in xylene at room temperature higher than 93% and a melt index (230° C.; 2.16 Kg) in the range of from 200 to 400 g/10′; and
(B) 10 to 50% of a copolymer of ethylene with propylene or higher alpha olefins soluble in xylene at room temperature and containing from 20 to 80% by weight of ethylene;
all the percentages being referred to the sum of A and B.
